(19) United States
(12) Patent Application Publication
(10) Pub. No.: US 2025/0307633 A1
(43) Pub. Date: Oct. 2, 2025

(54) CONVERTING AND UPTRAINING PERFORMANT TRANSFORMERS WITH FULL ATTENTION USING NORMALIZED RECURRENCE

(71) Applicant: Toyota Research Institute, Inc., Los Altos, CA (US)

(72) Inventors: Igor Vasiljevic, San Mateo, CA (US); Jean Mercat, Mountain View, CA (US); Sedrick Keh, Mountain View, CA (US); Achal Dave, San Francisco, CA (US); Kushal Arora, Seattle, WA (US); Thomas Kollar, San Jose, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/043,108

(22) Filed: Jan. 31, 2025

Related U.S. Application Data
(60) Provisional application No. 63/571,605, filed on Mar. 29, 2024.

(51) Int. Cl. G06N 3/082; G06F 17/16; G06N 3/0455; G06N 3/048

(52) U.S. Cl. CPC G06N 3/082; G06F 17/16; G06N 3/0455; G06N 3/048

(57) ABSTRACT

A method may include receiving parameters associated with a pre-trained transformer trained on first training data, modifying an architecture of the pre-trained transformer to generate a modified transformer, the modified transformer replacing a dot-product softmax attention layer with a linear kernel dot product attention layer utilizing Group Normalization, receiving second training data, and training the modified transformer based on the training data.

### CROSS-REFERENCE TO RELATED APPLICATION

The present specification is based on, and claims priority from U.S. Provisional Application No. 63/571,605, filed Mar. 29, 2024, the disclosure of which is hereby incorporated by reference in its entirety.

### TECHNICAL FIELD

The present specification relates to training large language models, and more particularly, to converting and uptraining performant transformers with full attention using normalized recurrence.

### BACKGROUND

Large language models (LLMs) have become a popular form of generative artificial intelligence in recent years. LLMs can receive a text prompt and generate text in response to the prompt. LLMs are typically trained using transformers, which have a high parallel training efficiency and scaling performance. A transformer is trained using training data comprising a large number of tokens (e.g., sequences of text). However, the training efficiency of transformers comes at the expense of an inference cost that scales linearly with the number of tokens. As such, the memory intensive nature of transformers has led to renewed interest in recurrent neural networks (RNN).

RNNs are another form of neural network that can be used for sequence modeling tasks. However, RNNs do not have the training efficiency and scaling performance of transformers. As such, transformers have largely displaced RNNs in sequence modeling tasks. However, while the inference cost of transformers scales linearly with the number of tokens, RNNs have a fixed cost at inference. Accordingly, there is a need for LLMs that have the training benefits of transformers, and the inference benefits of RNNs.

### SUMMARY

In one embodiment, a method may include receiving parameters associated with a pre-trained transformer trained on first training data, modifying an architecture of the pre-trained transformer to generate a modified transformer, the modified transformer replacing a dot-product softmax attention layer with a linear kernel dot product attention layer utilizing Group Normalization, receiving second training data, and training the modified transformer based on the training data.

In another embodiment, a computing device may comprise one or more processors configured to receive parameters associated with a pre-trained transformer trained on first training data, modify an architecture of the pre-trained transformer to generate a modified transformer, the modified transformer replacing a dot-product softmax attention layer with a linear kernel dot product attention layer utilizing Group Normalization, receive second training data, and train the modified transformer based on the training data.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1A schematically depicts an architecture of a vanilla transformer, according to one or more embodiments shown and described herein;

FIG. 1B schematically depicts a multi-head attention layer of the vanilla transformer of FIG. 1A, according to one or more embodiments shown and described herein;

FIG. 1C schematically depicts a scaled dot-product attention layer of the multi-head attention layer 116 of FIG. 1B, according to one or more embodiments shown and described herein;

FIG. 2A schematically depicts a linear cell that may be used in a modified transformer architecture, according to one or more embodiments shown and described herein;

FIG. 2B schematically depicts an RNN architecture, according to one or more embodiments shown and described herein;

FIG. 3 depicts a schematic diagram of a computing device for performing uptraining of a transformer, according to one or more embodiments shown and described herein; and

FIG. 4 depicts a flowchart of a method of operating the computing device of FIG. 3, according to one or more embodiments shown and described herein.

### DETAILED DESCRIPTION

The embodiments disclosed herein include a method of converting a transformer into an RNN. In embodiments, an LLM trained on high-quality, proprietary datasets (which are not available for linear model pre-training) may be used as a starting point (e.g., Llama 2). Such models are often trained on trillions of tokens. This pre-trained model may then be fine-tuned or uptrained for a small fraction of pre-training tokens with publically available data to obtain linear models that are competitive with the best linear transformers for a fraction of the compute cost, as disclosed herein.

Recurrent neural networks are a type of artificial neural network that may be used for sequential data processing. Unlike feed forward neural networks, which process data in a single pass, RNNs process data across multiple time steps, making them well-adapted for modeling and processing time series data such as text and speech. In operation, RNNs generate a sequence of hidden states as a function of the previous hidden state for a particular input position. This inherently sequential nature precludes parallelization within training examples, which becomes critical at longer sequence lengths, as memory constraints limit batching across examples.

In order to overcome the limitations of RNNs, the transformer model was developed. Rather than relying on recurrence, transformers rely on an attention mechanism to draw global dependencies between input and output. The transformer model allows for significantly more parallelization and has been used to train large language models.

In a transformer architecture used for LLMs, text is converted to numerical representations called tokens. Each token is then converted into a vector using word embedding. At each layer, each token is contextualized within the scope of a context window with other tokens via a parallel multi-head attention mechanism, which allows the signal for key tokens to be amplified and less important tokens to be diminished.

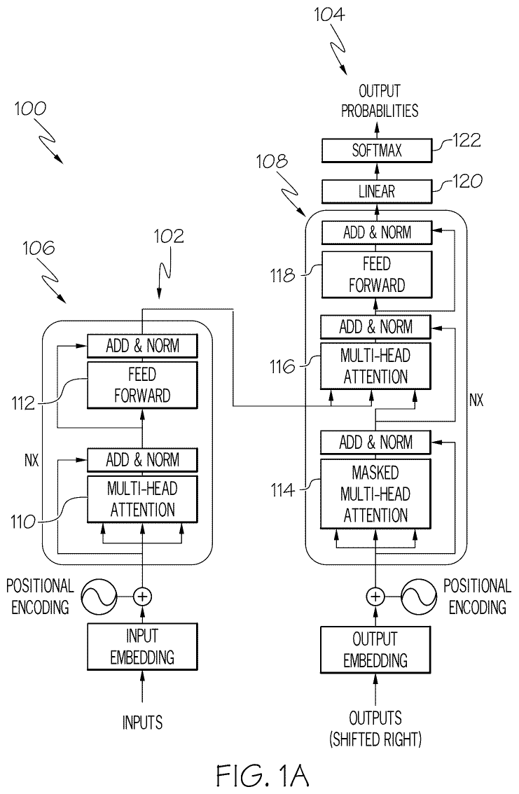

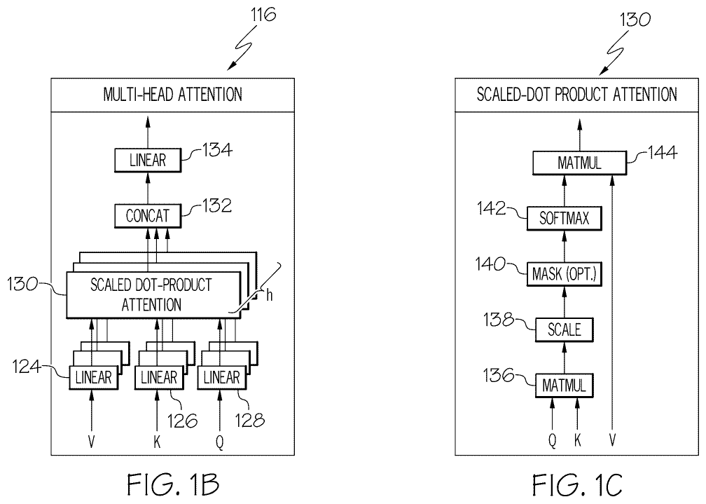

FIGS. 1A-1C show an example architecture of a vanilla transformer 100. As shown in FIG. 1A, the transformer 100 includes an encoder 102 and a decoder 104. The encoder 102 comprises one or more layers 106 and the decoder 104 comprises one or more layers 108. The layers 106 of the encoder 102 may be stacked on top of each other, and the layers 108 of the decoder 104 may be stacked on top of each other. While only a single layer 106 of the encoder 102 and a single layer 108 of the decoder 104 are shown in FIG. 1A, it should be understood that the encoder 102 and the decoder 104 may include any number of such layers.

Each layer 106 of the encoder 102 contains two sub-layers: a multi-head attention layer 110 and a fully connected feed forward layer 112. A residual connection may be employed around each of the two sub-layers, followed by layer normalization. That is, the output of each sub-layer is LayerNorm (x+Sublayer(x)) where Sublayer(x) is the function implemented by the sub-layer itself.

Each layer 108 of the decoder 104 comprises three sub-layers: a masked multi-head attention layer 114, a multi-head attention layer 116, and a fully connected feed forward network 118. The masked multi-head attention layer 114 performs multi-head attention over the output of the encoder stack. Similar to the encoder 102, the decoder 104 employs residual connections around each of the sub-layers, followed by layer normalization. The self-attention sub-layer in the decoder stack is modified to prevent positions from attending to subsequent positions. This masking, combined with the fact that the output embeddings are offset by one position, ensures that the predictions for position i can depend only on the known outputs at positions less than i. The decoder 104 also includes a linear transformation layer 120 and a softmax layer 122.

FIG. 1B shows an example architecture of the multi-head attention layer 116 of the decoder 104, although the multi-head attention layer 110 of the encoder 102 or the masked multi-head attention layer 114 of the decoder 104 may be constructed similarly. An attention function performed by the multi-head attention layer 116 can be described as mapping a query and a set of key-value pairs to an output, where the query, keys, values, and outputs are all vectors. The output is computed as a weighted sum of the values, where the weight assigned to each value is computed by a compatibility function of the query with the corresponding key. As shown in FIG. 1B, the multi-head attention layer 116 includes linear inputs V (a matrix of values), K (a matrix of keys), and Q (a matrix of queries), linear layers 124, 126, 128, a scaled dot-product attention layer 130, a concatenation output 132, and a linear output 134.

In the vanilla transformer 100, the attention is “Scaled Dot-Product Attention”, which can be performed by the scaled dot-product attention layer 130. FIG. 1C shows an example architecture of the scaled dot-product attention layer 130, which includes a matrix multiplication layer 136, a scale layer 138, an optional mask layer 140, a softmax layer 142, and another matrix multiplication layer 144. The input to the scaled dot-production attention layer 130 comprises queries and keys of dimension dk and values of dimension dy. A dot product is computed of the query with all keys by the matrix multiplication layer 136. The scale layer 138 then divides dot product is by dk. The softmax layer 142 then applies a softmax function to obtain the weights on the values. The softmax function is a normalization function that ensures that the sum of the components of the output vector is 1. In practice, the attention function is computed on a set of queries simultaneously, packed together into a matrix Q. The keys and values are also packed together into matrices K and V. The matrix of outputs is then computed as:

$$Attention ( Q , K , V ) = {V}^{′} = softmax ( \frac{{QK}^{T}}{\sqrt{{d}_{k}}} ) V \qquad ( 1 )$$

Transformers have outperformed RNNs in natural language generation tasks such as LLMs. However, this comes with a significant computational cost and memory footprint during generation. Since the output is incrementally predicted conditioned on the prefix, generation steps cannot be parallelized over time steps and require quadratic time complexity in sequence length. In particular, the computation of softmax dot product attention in equation (1) costs O(dN²) for a sequence length N of dimension d. The memory consumption in every generation step also grows linearly as the sequence becomes longer. This bottleneck for long sequence generation limits the use of large-scale pre-trained transformers. Accordingly, it may be desirable to use a more efficient transformer that uses a more memory efficient normalization function then the softmax function.

In equation (1), the self-attention function computes, for every position, a weighted average of the feature representations of all other positions with a weight proportional to a similarity score between the representations. In particular, in the softmax attention of equation (1), the similarity score is the exponential of the dot product between a query and a key. Given that subscripting a matrix with i returns the i-the row as a vector, we can write a generalized attention equation for any similarity function as follows:

$${V}^{′} = \frac{{\sum }_{j = 1}^{N} sim ( {Q}_{i} , {K}_{j} ) {V}_{j}}{{\sum }_{j = 1}^{N} sim ( {Q}_{i} , {K}_{j} )} \qquad ( 2 )$$

Equation (2) is equivalent to equation 1 if we substitute the similarity function with

$$sim ( q , k ) = exp ( \frac{{q}^{T} k}{\sqrt{D}} ) .$$

Furthermore, a kernel function ϕ(x) can be defined that maps queries and keys to their hidden representations. Given such a kernel, equation (2) can be rewritten as follows:

$${V}_{i}^{′} = \frac{{\sum }_{j = 1}^{N} {ϕ ( {Q}_{i} )}^{T} ϕ ( {K}_{j} ) {V}_{j}}{{\sum }_{j = 1}^{N} {ϕ ( {Q}_{i} )}^{T} ϕ ( {K}_{j} )} \qquad ( 3 )$$

The associative property of matrix multiplication can be used to rewrite equation (3) as follows:

$${V}_{i}^{′} = \frac{{ϕ ( {Q}_{i} )}^{T} {\sum }_{j = 1}^{N} ϕ ( {K}_{j} ) {V}_{j}}{{ϕ ( {Q}_{i} )}^{T} {\sum }_{j = 1}^{N} ϕ ( {K}_{j} )} \qquad ( 4 )$$

In equation (4), Q and K are decoupled. This means that Σⱼ₌₁^{N}ϕ(Kⱼ)Vⱼ and Σⱼ₌₁^{N}ϕ(Kⱼ) can be pre-computed and reused for every query. As such, the computational cost has time and memory complexity O(N) rather than O(N²) for the vanilla transformer 100. Thus, this modified transformer may be considered a linear transformer.

We can write sᵢ=Σⱼ₌₁ⁱϕ(Kⱼ)Vⱼ^{T} and zᵢ=Σⱼ₌₁ⁱϕ(Kⱼ) so that:

$${V}_{i}^{′} = \frac{{ϕ ( {Q}_{i} )}^{{τ}_{{S}_{i}}}}{{ϕ ( {Q}_{i} )}^{T} {z}_{i}} \qquad ( 5 )$$

sᵢ and zᵢ can be computed from sᵢ₋₁ and zᵢ₋₁, which means that at test time, we can express this as a recurrence. Using this formulation, each new token can be generated in constant time. Because sᵢ and zᵢ can be computed from their past values, they have the form of an RNN hidden state or memory.

Consider a stream of tokens that we want to generate X=[x₁, x₂, x₃, . . . ]. At inference time, the following update rule may be used, where subscripts denote timestep in the recurrence (calling kᵢ=W_{K}xᵢ, etc.):

$${s}_{0} = 0 ; {z}_{0} = 0 \qquad ( 6 )$$

$${s}_{i} = {s}_{i - 1} + ϕ ( {K}_{i} ) {V}_{i}^{T} \qquad ( 7 )$$

$${z}_{i} = {z}_{i - 1} + ϕ ( {K}_{i} ) \qquad ( 8 )$$

$${a}_{i} = \frac{{ϕ ( Q )}^{T} {s}_{i}}{{ϕ ( Q )}^{T} {z}_{i}} \qquad ( 9 )$$

The quantity sᵢ acts as a constant-size KV cache. Instead of appending new values to the cache, the state is updated. Therefore, the longer the inference sequence, the more computational gain this formulation offers. However, to claim this gain, model performance has to be demonstrated at such long sequence lengths. This architecture allows for O(1) inference, but performance lags vanilla attention transformers for natural language tasks. Furthermore, the normalization term zᵢ leads to unbounded gradients, which is an important stability issue.

To solve the above problems, in embodiments disclosed herein, a pre-trained transformer is uptrained, as disclosed herein. That is, instead of training a transformer model from scratch, a transformer model that has already been trained may be used as a starting point. This transformer may be a proprietary transformer model that has been trained on high quality training data. This transformer may then be uptrained using MLP kernel attention to convert the transformer into an RNN, as disclosed herein.

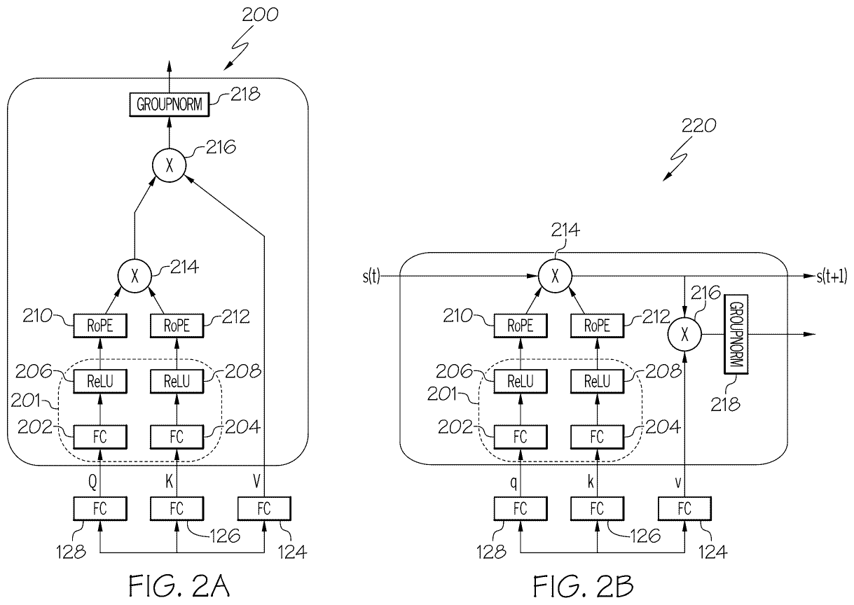

In embodiments, the architecture of the pre-trained transformer may be modified as disclosed herein. In particular, the pre-trained transformer may have the architecture of the vanilla transformer 100, as shown in FIGS. 1A-1C. Then, the architecture of the transformer 100 may be modified to replace the multi-head attention layers (e.g., 110, 114, 116 in FIG. 1A) with a linear cell 200, as shown in FIG. 2A. The linear cell 200 of FIG. 2A comprises a multi-layer perceptron (MLP) 201, rotary position embedding (RoPE) layers 210, 212, matrix multiplication operations 214, 216, and a GroupNorm operation 218. The MLP 201 comprises fully connected layers 202, 204, and rectified linear unit (ReLU) activation functions 206, 208.

The fully connected layers 202, 204 receive the outputs of the fully connected layers 128, 126, respectively. The fully connected layers 202, 204 comprise parameters that are trained during uptraining, as disclosed herein. The ReLU activation function is applied to the outputs of the fully connected layers 202, 204, such that the output of the MLP 201 can be written as ϕ(x)=ReLU(Wx+b). A rotary position embedding (RoPE) is then applied to the outputs of the MLP 201 such that the similarity function becomes:

$$sim ( {q}_{i} , {k}_{j} ) = RoPE ( ( ϕ ( {q}_{i} ) ) \cdot RoPE ( ϕ ( {k}_{j} ) ) ) \qquad ( 10 )$$

The outputs of the ROPE layers 210, 212 associated with the query matrix Q and the key matrix K, respectively, are multiplied together at operation 214. This output is then multiplied by the output of the fully connected layer 124 associated with the value Matrix V at operation 216.

This output is then normalized with a Group Normalization operation by the GroupNorm operation 218 instead of dividing by the sum of sim (qᵢ,kⱼ). Group Normalization may be referred to herein as GroupNorm. The linear cell 200 also uses a fixed decay vector y E (0,1)^{h} where h is the number of heads (not shown in FIG. 2A). As such, the output of the linear cell 200 can be written as follows:

$${v}_{i}^{′} = GroupNorm ( {\sum }_{j = 1}^{l} {γ}^{i - j} sim ( {q}_{i} , {k}_{j} ) {v}_{j} ) \qquad ( 11 )$$

The new parameters of the linear cell 200 are then trained jointly with the rest of the transformer network having the pre-trained parameters. That is, the entire modified network, including the linear cells 200, is uptrained with additional training data. In the illustrated example, the modified transformer architecture may be uptrained for about 5% to 10% of the token budget for the pre-trained transformer. However, in other examples, other amounts of training data may be used for uptraining.

The linear cell 200 of FIG. 2A is equivalent to the RNN cell shown in FIG. 2B. As such, after uptraining the parameters of the modified network, inference can be performed by replacing the linear cells 200 of FIG. 2A with the RNN cell 220 of FIG. 2B, as discussed in further detail below.

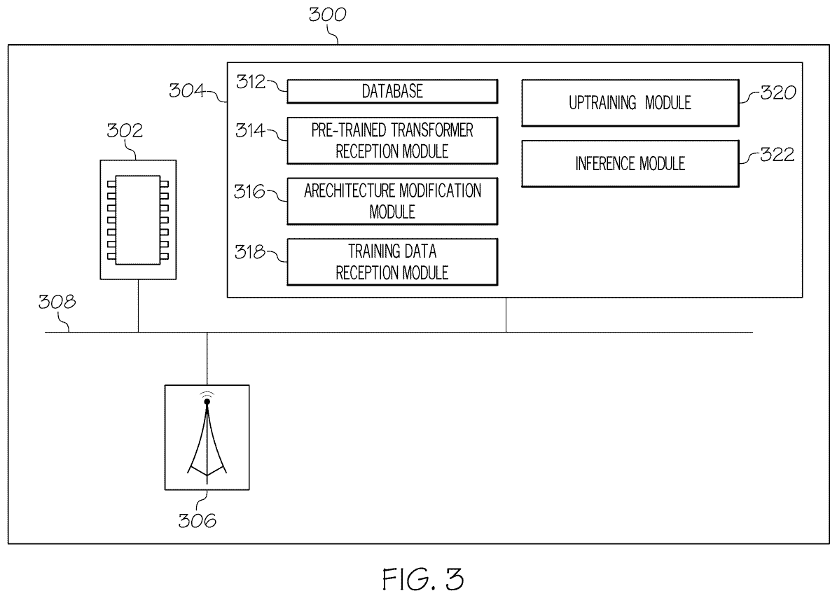

FIG. 3 depicts a computing device 300 for performing the operations described above. In particular, the computing device 300 may be used to receive parameters of a pre-trained transformer, modify the architecture, and uptrain the modified transformer, as described above.

In the example of FIG. 3, the computing device 300 comprises one or more processors 302, one or more memory modules 304, network interface hardware 306, and a communication path 308. The one or more processors 302 may be a controller, an integrated circuit, a microchip, a computer, or any other computing device. The one or more memory modules 304 may comprise RAM, ROM, flash memories, hard drives, or any device capable of storing machine readable and executable instructions such that the machine readable and executable instructions can be accessed by the one or more processors 302.

The network interface hardware 306 can be communicatively coupled to the communication path 308 and can be any device capable of transmitting and/or receiving data via a network. Accordingly, the network interface hardware 306 can include a communication transceiver for sending and/or receiving any wired or wireless communication. For example, the network interface hardware 306 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 306 includes hardware configured to operate in accordance with the Bluetooth® wireless communication protocol. The network interface hardware 306 of the computing device 300 may receive parameters of a pre-trained transformer, as disclosed in further detail below.

The one or more memory modules 304 include a database 312, a pre-trained transformer reception module 314, an architecture modification module 316, a training data reception module 318, an uptraining module 320, and an inference module 322. Each of the database 312, the pre-trained transformer reception module 314, the architecture modification module 316, the training data reception module 318, the uptraining module 320, and the inference module 322 may be a program module in the form of operating systems, application program modules, and other program modules stored in the one or more memory modules 304. In some embodiments, the program module may be stored in a remote storage device that may communicate with the computing device 300. Such a program module may include, but is not limited to, routines, subroutines, programs, objects, components, data structures and the like for performing specific tasks or executing specific data types as will be described below.

The database may store parameters of a pre-trained transformer received by the pre-trained transformer reception module 314, parameters of the modified transformer, and training data to uptrain the modified transformer.

The pre-trained transformer reception module 314 may receive parameters of a pre-trained transformer. As discussed above, a pre-trained transformer (e.g., a proprietary model trained on high-quality training data) may be used as a starting point for uptraining. As such, the pre-trained transformer reception module 314 may receive the parameters of a pre-trained transformer model to be uptrained (e.g., parameters of the vanilla transformer 100).

The architecture modification module 316 may modify the architecture of the pre-trained transformer associated with the pre-trained parameters received by the pre-trained transformer reception module 314. In particular, as discussed above, the architecture modification module 316 may replace each attention layer of the pre-trained transformer (e.g., layers 110, 114, 116 of the transformer 100 shown in FIG. 1A) with the linear cell 200 of FIG. 2A.

The training data reception module 318 may receive training data for uptraining the modified transformer generated by the architecture modification module 316. In particular, as discussed above, the modified transformer may be trained using only a fraction of the tokens used to train the original pre-trained model (e.g., 5% to 10% of the tokens). In some examples, the actual training data used to train the pre-trained model may be available. In these examples, a portion of this training data may be used to uptrain the modified transformer model. However, if the actual training data used to pre-train the transformer is not available (e.g. a proprietary model was used as the pre-trained model), then any set of tokens may be used for uptraining. Ideally, the tokens comprising the training data used to uptrain the modified transformer are drawn from a similar distribution as the tokens used to train the original pre-trained transformer.

The uptraining module 320 may uptrain the modified transformer generated by the architecture modification module 316 using the training data received by the training data reception module 318. In particular, the weights of the fully connected layers 202 and 204 of each linear cell 200 added by the architecture modification module 316 may be initialized with random values. The other parameters of the modified transformer may initially utilize the pre-trained values received by the pre-trained transformer reception module 314. The entire modified transformer may then be trained using the training data received by the training data reception module 318. The uptraining module 320 may train the modified transformer using known techniques. After the modified transformer is trained by the uptraining module 320, the parameters of the trained model may be stored in the database 312.

The inference module 322 may receive a query, and generate a response to the query using the trained modified transformer. In the illustrated example, during inference, each linear cell 200 of the modified transformer may be replaced by the RNN cell 220, as shown in FIG. 2B. The RNN cell 220 is mathematically equivalent to the linear cell 200. However, in the example of FIG. 2B, each state is determined sequentially, and as such, the RNN cell 220 uses less memory than the linear cell 200. In particular, because the pre-trained transformer has been effectively linearized and functionally converted to an RNN, the computing resources of inference are O(N) rather than O(N²) as would be the case of the vanilla transformer 100. Accordingly, inference is able to be performed more efficiently with the modified transformer than a vanilla transformer.

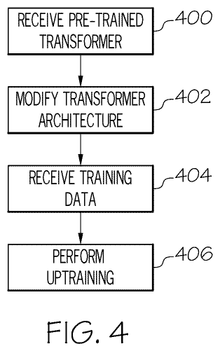

FIG. 4 depicts a flowchart of an example method for operating the computing device 300 for uptraining a pre-trained transformer. At step 400, the pre-trained transformer reception module 314 receives parameters of a pre-trained transformer. At step 402, the architecture modification module 316 modifies the architecture of the transformer model associated with the received parameters of the pre-trained transformer by replacing the each attention layer, as shown in FIG. 1B, with the linear cell 200 shown in FIG. 2A. At step 404, the training data reception module 318 receives data to be used to uptrain the modified transformer. At step 406, the uptraining module 320 uses the received training data to uptrain the modified transformer, as discussed above.

It should now be understood that embodiments described herein are directed to converting and uptraining performant transformers with full attention using normalized recurrence. By modifying a pre-trained transformer to replace softmax normalization with GroupNorm normalization, a linear transformer can be generated that performs inference much more efficiently than a vanilla transformer. Furthermore, only a small fraction of the tokens used to train the original transformer need to be used to uptrain the modified transformer. As such, a modified transformer may be used for LLMs or other applications with more efficient inference capabilities.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving parameters associated with a pre-trained transformer trained on first training data;
modifying an architecture of the pre-trained transformer to generate a modified transformer, the modified transformer replacing a dot-product softmax attention layer with a linear kernel dot product attention layer utilizing Group Normalization;
receiving second training data; and
training the modified transformer based on the training data.

2. The method of claim 1, wherein:
the pre-trained transformer comprises a vanilla transformer architecture having a plurality of multi-head attention layers using softmax normalization; and
the modified transformer uses a linear cell in place of one or more of the multi-head attention layers, the linear cell using Group Normalization in place of softmax normalization.

3. The method of claim 2, wherein the linear cell comprises:
a first fully connected layer associated with a query matrix;
a second fully connected layer associated with a key matrix;
a third fully connected layer associated with a value matrix;
a fourth fully connected layer to receive an output of the first fully connected layer; and
a fifth fully connected layer to receive an output of the second fully connected layer.

4. The method of claim 3, wherein:
the first fully connected layer, the second fully connected layer, and the third fully connected layer are included in the pre-trained transformer; and
the fourth fully connected layer and the fifth fully connected layer are not included in the pre-trained transformer.

5. The method of claim 3, wherein the linear cell further comprises:
a first rectified linear unit (ReLU) activation function to be performed on an output of the fourth fully connected layer; and
a second ReLU activation function to be performed on an output of the fifth fully connected layer.

6. The method of claim 5, wherein the linear cell further comprises:
a first rotary position embedding (RoPE) applied to an output of the first ReLU activation function; and
a second RoPE applied to an output of the second ReLU activation function.

7. The method of claim 5, wherein the linear cell further comprises:
a first matrix multiplication operation between an output of the first RoPE and an output of the second RoPE.

8. The method of claim 7, wherein the linear cell further comprises:
a second matrix multiplication operation between an output of the first matrix multiplication operation and an output of the third fully connected layer.

9. The method of claim 3, wherein the linear cell further comprises a fixed decay vector based on a number of heads in the modified transformer.

10. The method of claim 1, further comprising:
receiving a query;
inputting the query into the trained modified transformer; and
generating a response to the query based on an output of the trained modified transformer.

11. A computing device comprising one or more processors configured to:
receive parameters associated with a pre-trained transformer trained on first training data;
modify an architecture of the pre-trained transformer to generate a modified transformer, the modified transformer replacing a dot-product softmax attention layer with a linear kernel dot product attention layer utilizing Group Normalization;
receive second training data; and
train the modified transformer based on the training data.

12. The computing device of claim 11, wherein:
the pre-trained transformer comprises a vanilla transformer architecture having a plurality of multi-head attention layers using softmax normalization; and
the modified transformer uses a linear cell in place of one or more of the multi-head attention layers, the linear cell using Group Normalization in place of softmax normalization.

13. The computing device of claim 12, wherein the linear cell comprises:
a first fully connected layer associated with a query matrix;
a second fully connected layer associated with a key matrix;
a third fully connected layer associated with a value matrix;
a fourth fully connected layer to receive an output of the first fully connected layer; and
a fifth fully connected layer to receive an output of the second fully connected layer.

14. The computing device of claim 13, wherein:
the first fully connected layer, the second fully connected layer, and the third fully connected layer are included in the pre-trained transformer; and
the fourth fully connected layer and the fifth fully connected layer are not included in the pre-trained transformer.

15. The computing device of claim 13, wherein the linear cell further comprises:
a first rectified linear unit (ReLU) activation function to be performed on an output of the fourth fully connected layer; and
a second ReLU activation function to be performed on an output of the fifth fully connected layer.

16. The computing device of claim 15, wherein the linear cell further comprises:
a first rotary position embedding (RoPE) applied to an output of the first ReLU activation function; and
a second RoPE applied to an output of the second ReLU activation function.

17. The computing device of claim 15, wherein the linear cell further comprises:
a first matrix multiplication operation between an output of the first RoPE and an output of the second RoPE.

18. The computing device of claim 17, wherein the linear cell further comprises:
a second matrix multiplication operation between an output of the first matrix multiplication operation and an output of the third fully connected layer.

19. The computing device of claim 13, wherein the linear cell further comprises a fixed decay vector based on a number of heads in the modified transformer.

20. The computing device claim 11, wherein the computing device further causes the one or more processors to:
receive a query;
input the query into the trained modified transformer; and
generate a response to the query based on an output of the trained modified transformer.
